(19) United States
(12) Patent Application Publication
(10) Pub. No.: US 2004/0158660 A1
(43) Pub. Date: Aug. 12, 2004

(54) External keyboard device and transmission method for commands

(76) Inventor: Dean Lin, Taipei Hsien (TW)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/359,541

(22) Filed: Feb. 7, 2003

(51) Int. Cl. G06F 13/12

(52) U.S. Cl. 710/72

(57) ABSTRACT

The present invention discloses an external keyboard device and the transmission method for commands, which provides the function of NumLock, such that it can manually switch the numerical mode or functional mode, and automatically detect the state of NumLock key on the notebook PC being ON or OFF under the numerical mode or the functional mode to determine if it is necessary to embed the control signal for NumLock_ON or NumLock_OFF before or after the signal during the output for the key signal and then transmit to the notebook PC. Thus, the user can use the external keyboard device to directly conduct the input in the numerical mode or functional mode.

### BACKGROUND OF THE INVENTION

1. Field of the Invention

The present invention relates to an external keyboard device and a transmission method for commands. More specifically, the present invention is an external multi-functional keyboard, which can be connected to and disconnected from a computer body, such as the notebook PC. The keyboard device has a NumLock key function, which not only allows switching between the numerical mode and the functional mode, but also can automatically detect the state of NumLock key on the notebook PC as being ON or OFF under either the numerical mode or the functional mode. Thus, the user can use the external keyboard device to directly input a numerical key for numerical mode or a functional key for functional mode.

2. Description of Prior Art

In the prior art, because of the compact size of the notebook PC, it is necessary to provide a NumLock key on the keyboard to switch between the text and numerical modes. In a keyboard without the numerical keys, the alphabetical keys on the keyboard are used as the numerical keys when the state of the NumLock key is ON. When using a keyboard without the numerical keys, the user has to frequently press the NumLock key to input the numbers, so that he may use the external keyboard device to directly input the numbers.

The conventional external keyboard device only has the numerical keys. When the state of the NumLock key on the keyboard of the notebook PC is OFF, the external keyboard device still can be used to input the numbers, and will embed the signals of NumLock_ON and NumLock_OFF before and after the signal for the numerical keys.

For the external keyboard device with the above-mentioned structure, the user needs not to set the NumLock key on the keyboard as ON in order to input the numbers using the external keyboard device. Although it can eliminate the inconvenience of inputting complicated numbers, the external keyboard device does not have the input of function keys. As a result, it can only provide the external input in numerical mode, but cannot provide any input in functional mode for the user.

The object of the present invention is to provide an external keyboard device and a transmission method for commands. This external keyboard device can use the NumLock key function on a computer host to switch between the numerical mode and the functional mode, and to automatically determine the corresponding definitions in the numerical mode or the functional mode to the keys by the ON/OFF states of the NumLock key to output the corresponding key codes. By automatically detecting the state of the NumLock key function on the notebook PC as being ON or OFF, the external keyboard device then determines if the key signal transmitted from the external keyboard device to the notebook PC has to embed the control signals of NumLock_ON or NumLock_OFF before and after the signal. The present invention as described further improves upon the prior art and provides convenience for the user when using the numerical mode or the functional mode.

### SUMMARY OF THE INVENTION

In consideration of the prior art, although the external keyboard device can solve the inconvenience of inputting numbers on the conventional keyboard of a notebook PC, the external keyboard device can only be used as the external input for numbers, but cannot provide the input functions in the functional key mode for the user.

The present invention provides an external keyboard device and the transmission method for commands, wherein the convenience of the user for inputting in the numerical mode or the functional mode can be improved by connecting a key sensing member, a key position decoding member, a NumLock state recording member, a detection member for NumLock state in system, and an embedding control member between the notebook PC and the external keyboard device. In this invention, the input of the numerical keys/functional keys on the external keyboard device is completed by the key sensing member and the key position decoding member in a current conduction manner to sense the pressing action and decode the position of the key being pressed. Next, the decoding member for the NumLock state monitors the ON/OFF state of the NumLock key function for the external keyboard device. The present invention further combines a NumLock ON index table and a NumLock OFF index table to correspondingly provide the output function in the numerical key mode or in the functional key mode according to the ON/OFF state of the NumLock key function for the external keyboard device, with an embedding control member for NumLock ON/OFF signal in association with a detection member for the NumLock state in the system to embed the NumLock_ON or NumLock_OFF signals in the outputted key signal for output based on the ON/OFF state of the NumLock key on the notebook PC. Here, the embedding of NumLock_ON and NumLock_OFF signals before and after the outputted key signals is to set the NumLock key on the notebook PC as ON, and then to transmit the numerical signals, and to recover the NumLock key on the notebook PC as OFF after the completion for transmission. Thus, the user can use the external keyboard device to directly conduct the input in the numerical mode or in the functional mode, so as to improve the convenience for the user by allowing input in either the numerical mode or in the functional mode from an improved external keyboard device.

### BRIEF DESCRIPTIONS OF THE DRAWINGS

FIG. 1 is a three-dimensional diagram of a connection example of the external keyboard device according to the present invention;

FIG. 2 is a structural block diagram of the external keyboard device according to the present invention; and

FIG. 3 is an implementation flow chart for command transmission for the external keyboard device according to the present invention.

### DETAILED DESCRIPTION OF THE INVENTION

Although the present invention is referenced with the appended figures for the preferred embodiment in the present invention, it should be appreciated that those who are skilled in the present art may modify the invention described in the specification and achieve the same effect as the present invention. Thus, it should be appreciated that the following description is construed as a broad disclosure to those who are skilled in the present art, and the disclosure does not limit the present invention.

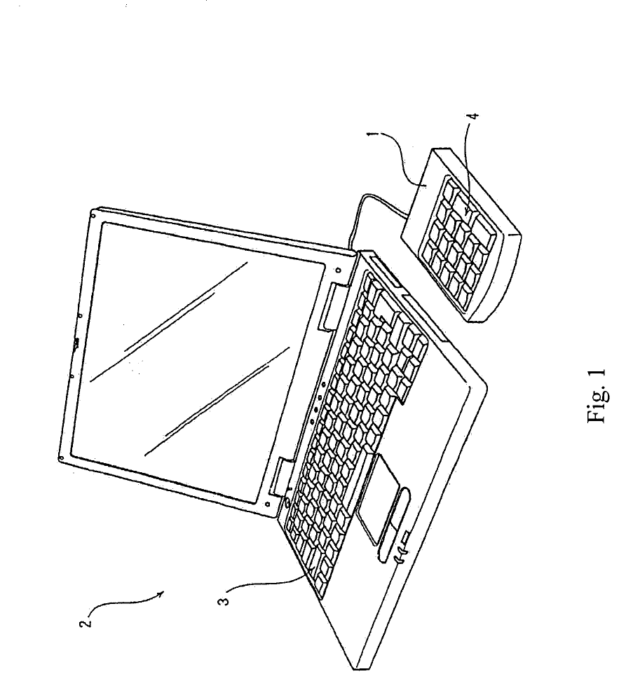

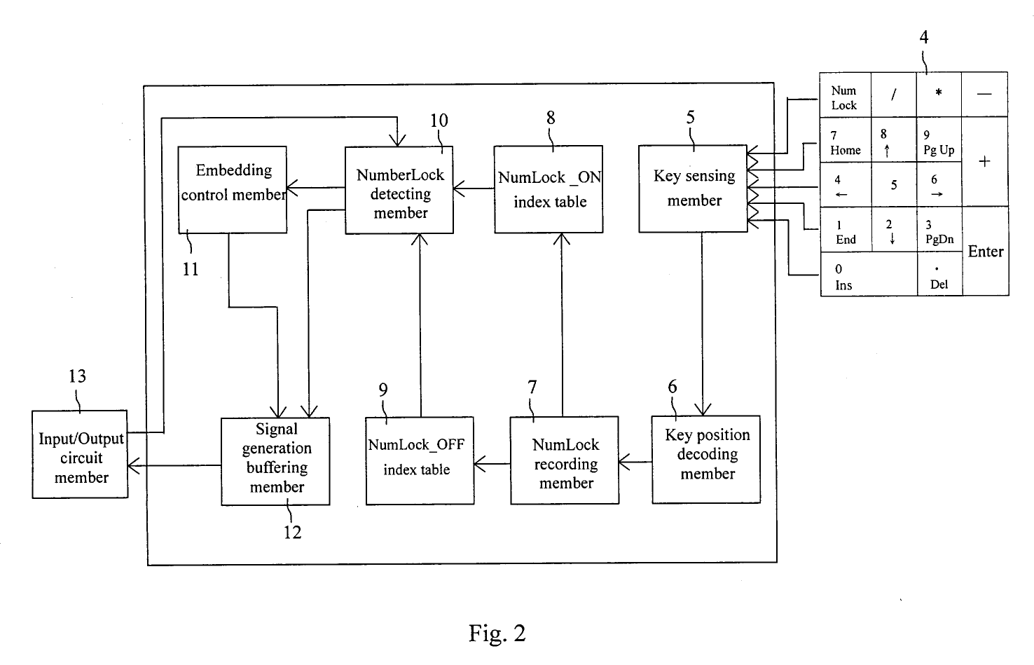

FIG. 1 and FIG. 2 are the three-dimensional and structural block diagrams that illustrate the connection between the external keyboard device and a notebook PC according to the present invention. As shown in FIG. 2, an external keyboard device 1 in a preferred embodiment according to the present invention at least comprises: a key sensing member 5 for receiving the current conduction signal inputted by the pressing of the user; a key position decoding member 6 for receiving the current conduction signal inputted by the key sensing member 5 and decoding the key position; a recoding member 7 of NumLock state for detecting the ON/OFF state of the NumLock key on the external keyboard device 1 to determine the data mode to be transmitted; a detecting member 10 of NumLock state in system for detecting the ON/OFF state of the NumLock key on the notebook PC 2; an embedding control member 11 for NumLock ON/OFF signal for embedding the NumLock_ON and NumLock_OFF signals before and after the input signal in numerical mode according to the ON/OFF state of the NumLock key on the notebook PC 2, and for setting the NumLock key on the notebook PC being ON to transmit the numerical signal, and for recovering the NumLock key of the system being OFF after the completion of transmission; a signal generation buffering member 12 for storing the input signals from the detecting member 10 of NumLock state in system and the embedding control member 11 of NumLock ON/OFF signals and transmitting to an input/output circuit member 13; and, an input/output circuit member 13, for conducting the key signal from the external keyboard device 1 and receiving the ON/OFF state signal of the NumLock key on the keyboard 3 of the notebook PC 2. Notebook PC 2 is connected to the signal output of the signal generation buffering member 12 and the signal input of the detecting member 10 of NumLock state in system.

In addition, the external keyboard device 1 further comprises a NumLock_ON index table 8that provides the numerical mode definitions for the keys corresponding to the NumLock_ON signal inputted by the recording member 7 for NumLock state, and a NumLock_OFF index table 9 that provides the functional mode definitions for the keys corresponding to the NumLock_OFF signal inputted by the recording member 7 for NumLock state.

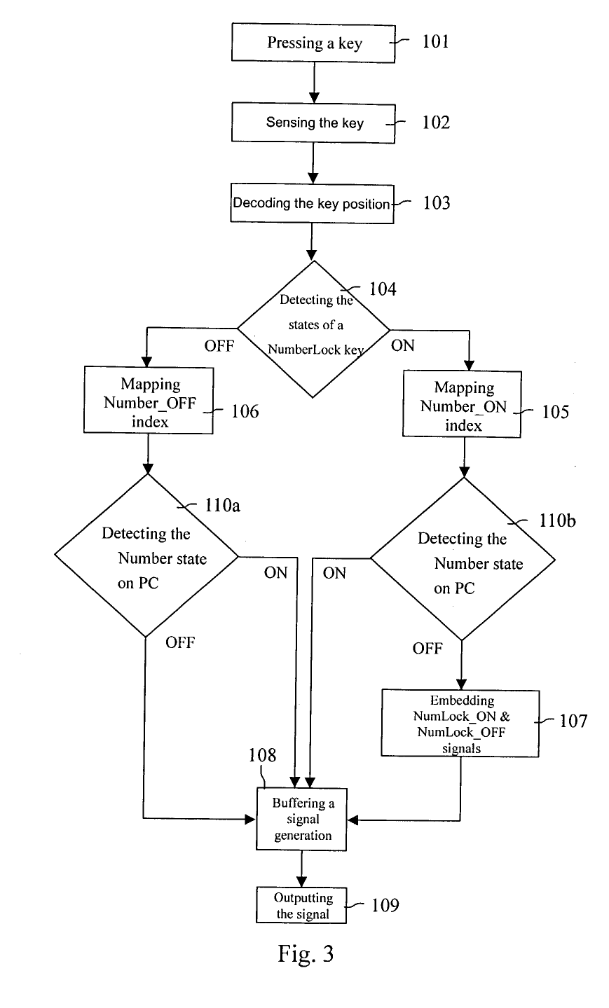

Referring to FIG. 3 in association with FIG. 1 and FIG. 2, it shows an implementation flow chart of command transmission in the external keyboard device according to the present invention. The command transmission method implemented by the external keyboard device according to the present invention includes the following procedures:

Procedure 101: Pressing the Keyboard

This procedure means that the user presses the additional numerical function keyboard 4 to input the key signal.

Procedure 102: Key Sensing

In this procedure, the key sensing member 5 will receive a current signal activated by the user's pressing the numerical function keyboard 4.

Procedure 103: Decoding of Key Position

The procedure is to decode the key position on the current conduction signal inputted by the key sensing member 5 in the procedure 102 with a key position decoding member 6 to determine which key is activated and then proceed to the next procedure 104.

Procedure 104: NumLock State Recording

When the position decoding results from the key position decoding member 6 in the procedure 103 is transmitted to a NumLock state recording member 7, the NumLock state recording member 7 will transmit the corresponding NumLock_ON index table 8 or NumLock_OFF index table 9 according to the NumLock ON/OFF state in the additional numerical function keyboard 4. If the NumLock state recording member 7 is at ON state, the next procedure is procedure 105. If the NumLock state recording member 7 is at OFF state, the next procedure is procedure 106.

Procedure 105: NumLock ON Indexing

When the NumLock key of the additional numerical function keyboard 4 in the NumLock state recording member 7 is at ON state in the procedure 104, the key code in the NumLock_ON index table 8 for the numerical key reveal the key input is at the numerical mode, and the value will be transmitted to the detecting member 10 for NumLock state in system and to be allowed to proceed to the next procedure 110b.

Procedure 106: NumLock_OFF Indexing

When the NumLock key of the additional numerical function keyboard 4 in the NumLock state recording member 7 is at OFF state in procedure 104, the key code in the NumLock_OFF index table 9 for the numerical key will be determined, and will represent the key input is at the functional mode. The corresponding value will be transmitted to the detecting member 10 for NumLock state in system. Afterwards, the process proceed to procedure 110a.

Procedure 110a/110b: Detection of NumLock State in System

Both procedures 110a and 110b detect the NumLock key state on the notebook PC 2 according to the output of the corresponding value in the index table from procedures 106 and 105, respectively. If the detection of NumLock key state on the notebook PC 2 is OFF because the NumLock state recording member 7 being was at the OFF state, the process moves to procedure 108. If the detection of NumLock key state on the notebook PC 2 is ON because the NumLock state recording member 7 was at the ON state, then the process determines whether the combined system is at ON or OFF state. If the combined system is at the ON state, then the process moves to procedure 108. If the combined system is at the OFF state, then the process moves to procedure 107.

Procedure 107: Embedding control for NumLock ON/OFF signal. At this point, the transmitting corresponding value of the index table is ON, suggesting a transmission in numerical mode. Then, the corresponding value has to be transmitted to the embedding control member 11 for NumLock ON/OFF signal here in procedure 107. First, the NumLock_ON control signal is transmitted to set the NumLock state of the notebook PC 2 at the ON position and to allow the system to output the numerical signals. Next, the NumLock_OFF control signal is transmitted to recover the NumLock state of the system back to the OFF position. As a side note, in procedure 110a, if the state of NumLock key on the notebook PC is detected as being ON or OFF, the transmitting corresponding value of the index table shows that the system performs transmission in the functional mode, which needs not to embed the NumLock_ON and NumLock_OFF control signals, and can directly transmit commands to signal generation buffering member 12 to further proceed with the procedures 108 and 109.

Procedure 108: Signal Generation Buffering

At this point, the signal generation buffering member 12 receives the corresponding value signal generated during the execution of procedure 110a/110b and/or procedure 107. The corresponding key signal embedded with NumLock_ON and NumLock_OFF controls signals therebefore and thereafter.

Procedure 109: Signal Output

The device transmits the corresponding value data received by the procedure 108 to notebook PC 2 through the input/output circuit member 13.

It may be appreciated by the skilled in the art that, in light of the detailed description of the preferred embodiments of the present invention, many other possible variations and modifications can be created without departing from the scope and spirit of the claims, and that the present invention is not limited to the implementation of the embodiments in the description.

The external keyboard device and the transmission method for commands in the present invention have many advantages and features. The present invention provides an external keyboard device and the transmission method for commands, wherein the user can use the external keyboard device with numerical input mode and functional input mode. The external keyboard and the transmission method for commands together can automatically determine the corresponding definitions for numerical mode and functional mode to the keys according to the ON/OFF state of the NumLock key on the external keyboard device and for output. Furthermore, by automatically detecting the NumLock function on the notebook PC being ON or OFF, the invention can determine if it is necessary to embed the control signals of NumLock_ON or NumLock_OFF before and after the data during outputting the keys. Thus, the convenience for the user on inputting in numerical mode or functional mode can be further improved.

We claim:

1. A command transmission method for external key commands for an additional numerical functional keyboard having a NumLock key, wherein the keyboard can be connected to a PC, comprising the following steps:
recording ON/OFF state of the NumLock key;
detecting ON/OFF state of NumLock state of the PC;
transmitting numerical key signals embedded with a NumLock ON command therebefore and a NumLock OFF command thereafter when the NumLock key is at ON state and the NumLock state of the PC is OFF; and
transmitting functional key signals when the NumLock key is at OFF state or ON state and the NumLock state of the PC is at ON state.

2. The command transmission method as claimed in claim 1, further comprising the following step: looking up a key code of numerical key based on a NumLock_ON index table when the NumLock key is at ON state.

3. The command transmission method as claimed in claim 1, further comprising the following step: looking up a key code of the numerical key based on a NumLock_OFF index table when the NumLock key is at OFF state.

4. An external keyboard device having a NumLock key, at least comprising:
a key sensing member, for receiving a current signal activated by a key;
a key position decoding member, for receiving current signal and decoding a key position corresponding to the key;
a NumLock recoding member, for detecting ON/OFF state of the NumLock key to determine a numerical mode or a functional mode;
a NumLock detecting member, for detecting ON/OFF state of a NumLock state on a PC and outputting a key signal;
an embedding control member, for embedding a NumLock_ON signal before and a NumLock_OFF signal after the key signal on the numerical mode;
a signal generation buffering member, for storing the key signal that embedded the NumLock_ON and NumLock_OFF signals on the numerical mode and the key signal on the functional mode; and
an input/output circuit member, for connecting the signal generation buffering member and transmitting the key signal to the PC.

5. The external keyboard device as claimed in claim 4, further comprising a NumLock_ON index table and a NumLock_OFF index table.

6. The external keyboard device as claimed in claim 5, wherein the NumLock_ON index table is used to provide the key code corresponding to a key on the numerical mode.

7. The external keyboard device as claimed in claim 5, wherein the NumLock_OFF index table is used to provide the key code corresponding to the key on the functional mode.

8. The external keyboard device as claimed in claim 4, wherein the input/output circuit member connects to an input terminal of the PC for transmitting the key signal.

9. The external keyboard device as claimed in claim 4, wherein the NumLock_ON signal is used to enable the numerical mode on the PC, and the NumLock_OFF signal is used to disable the numerical mode on the PC.
